(19) United States
(12) Patent Application Publication
(10) Pub. No.: US 2013/0114070 A1
(43) Pub. Date: May 9, 2013

(54) Targeted Agile Raman System for Detection of Unknown Materials

(71) Applicant: ChemImage Corporation, Pittsburgh, PA (US)

(72) Inventors: Charles Gardner, JR., Gibsonia, PA (US); Matthew Nelson, Harrison City, PA (US)

(73) Assignee: ChemImage Corporation, Pittsburgh, PA (US)

(21) Appl. No.: 13/729,220

(22) Filed: Dec. 28, 2012

Related U.S. Application Data
(63) Continuation-in-part of application No. 12/802,994, filed on Jun. 17, 2010, now Pat. No. 8,379,193.

(51) Int. Cl. G01J 3/44

(52) U.S. Cl. 356/73

(57) ABSTRACT

The present disclosure provides for a system and method for detecting unknown materials. A test data set, which may comprise a hyperspectral data set, is generated representative of a first location. The test data set may be analyzed to determine a second location which may be interrogated using a Raman spectrocscopic device to generate a Raman data set. The Raman data set may be analyzed to associated an unknown material with a known material such as: a chemical material, a biological material, an explosive material, a hazardous material, a drug material, and combinations thereof.

### RELATED APPLICATIONS

This application is a continuation-in-part to pending U.S. patent application Ser. No. 12/802,994, filed on Jun. 17, 2010, entitled “SWIR Targeted Agile Raman (STAR) System for On-the-Move Detection of Emplace Explosives,” which is hereby incorporated by reference in its entirety.

### BACKGROUND

Spectroscopic imaging combines digital imaging and molecular spectroscopy techniques, which can include Raman scattering, fluorescence, photoluminescence, ultraviolet, visible and infrared absorption spectroscopies. When applied to the chemical analysis of materials, spectroscopic imaging is commonly referred to as chemical imaging. Instruments for performing spectroscopic (i.e. chemical) imaging typically comprise an illumination source, image gathering optics, focal plane array imaging detectors and imaging spectrometers.

In general, the sample size determines the choice of image gathering optic. For example, a microscope is typically employed for the analysis of sub micron to millimeter spatial dimension samples. For larger objects, in the range of millimeter to meter dimensions, macro lens optics are appropriate. For samples located within relatively inaccessible environments, flexible fiberscope or rigid borescopes can be employed. For very large scale objects, such as planetary objects, telescopes are appropriate image gathering optics.

For detection of images formed by the various optical systems, two-dimensional, imaging focal plane array (FPA) detectors are typically employed. The choice of FPA detector is governed by the spectroscopic technique employed to characterize the sample of interest. For example, silicon (Si) charge-coupled device (CCD) detectors or CMOS detectors are typically employed with visible wavelength fluorescence and Raman spectroscopic imaging systems, while indium gallium arsenide (InGaAs) FPA detectors are typically employed with near-infrared spectroscopic imaging systems.

Spectroscopic imaging of a sample can be implemented by one of two methods. First, a point-source illumination can be provided on the sample to measure the spectra at each point of the illuminated area. Second, spectra can be collected over the an entire area encompassing the sample simultaneously using an electronically tunable optical imaging filter such as an acousto-optic tunable filter (AOTF) or a liquid crystal tunable filter (“LCTF”). Here, the organic material in such optical filters are actively aligned by applied voltages to produce the desired bandpass and transmission function. The spectra obtained for each pixel of such an image thereby forms a complex data set referred to as a hyperspectral image which contains the intensity values at numerous wavelengths or the wavelength dependence of each pixel element in this image.

Spectroscopic devices operate over a range of wavelengths due to the operation ranges of the detectors or tunable filters possible. This enables analysis in the Ultraviolet (UV), visible (VIS), near infrared (NIR), short-wave infrared (SWIR), mid infrared (MIR) wavelengths and to some overlapping ranges. These correspond to wavelengths of about 180-380 nm (UV), 380-700 nm (VIS), 700-2500 nm (NIR), 900-1700 n (SWIR), and 2500-25000 nm (MIR).

There exists a need for accurate and reliable detection of unknown materials at standoff distances. Additionally, it would be advantageous if a standoff system and method could be configured to operate in an On-the-Move (OTM) mode. It would also be advantageous if a system and method could be configured for deployment on a small unmanned ground vehicle (UGV).

### SUMMARY

The present invention relates generally to a system and method for detecting unknown materials in a sample scene. More specifically, the present disclosure elates to scanning sample scenes using hyperspectral imaging and then interrogating of areas of interest using Raman spectroscopy. One term that may be used to describe the system and method of the present disclosure is Agile laser Scanning (“ALS”) Raman spectroscopy. The term is used to describe the ability to focus the area of interrogation by Raman spectroscopy to those areas defined by hyperspectral imaging with high probabilities of comprising unknown materials. Examples of materials that may be assessed using the system and method of the present disclosure may include, but are not limited to, chemical, biological, and explosive threat agents as well as other hazardous materials and drugs (both legal and illicit).

Hyperspectral imaging may be implemented to define areas where the probability of finding unknown materials is high. The advantage of using hyperspectral imaging in a scanning mode is its speed of analysis. Raman spectroscopy provides for chemical specificity and may therefore be implemented to interrogate those areas of interest identified by the hyperspectral image. The present disclosure provides for a system and method that combines these two techniques, using the strengths of each, to provide for a novel technique of achieving rapid, reliable, and accurate evaluation of unknown materials. The system and method also hold potential for providing autonomous operation as well as providing considerable flexibility for an operator to tailor searching for specific applications.

The present disclosure contemplates both static and On-the-Move (“OTM”) standoff configurations. The present disclosure also contemplates the implementation of the sensor system of the present disclosure onto an Unmanned Ground Vehicle (“UGV”). Integration of these sensors onto small UGV platforms in conjunction with specific laser systems may be configured to achieve a pulsed laser system with a size, weight, and power consumption compatible with small UGV operation. Such a configuration holds potential for implementation in a laser-based OTM explosive location system on a small UGV.

The present disclosure also provides for the application of various algorithms to provide for data analysis and object imaging and tracking. These algorithms may further comprise image-based material detection algorithms, including tools that may determine the size, in addition to identity and location, of unknown materials. Providing this information to an operator may hold potential for determining the magnitude of unknown materials in a wide area surveillance mode. Additionally, algorithms may be applied to provide for sensor fusion. This fusion of Raman and other spectroscopic and/or imaging modalities holds potential for reducing false alarm rates.

### BRIEF DESCRIPTION OF THE DRAWINGS

The accompanying drawings, which are included to provide further understanding of the disclosure and are incorporated in and constitute a part of this specification, illustrate embodiments of the disclosure and, together with the description, serve to explain the principles of the disclosure.

FIG. 1 is illustrative of a method of the present disclosure.

FIG. 2 is illustrative of a method of the present disclosure.

FIG. 3 is a schematic representation of a system of the present disclosure.

FIG. 4 is a schematic representation of a FAST device.

FIG. 5 is a schematic representation of a FAST device illustrating spatial knowledge of the various fibers.

FIG. 6 is illustrative of the FAST device and its basic operation.

FIG. 7 is illustrative of a target-tracking algorithm of the present disclosure.

### DETAILED DESCRIPTION

Reference will now be made in detail to the embodiments of the present disclosure, examples of which are illustrated in the accompanying drawings. Wherever possible, the same reference numbers will be used throughout the drawings to refer to the same or like parts.

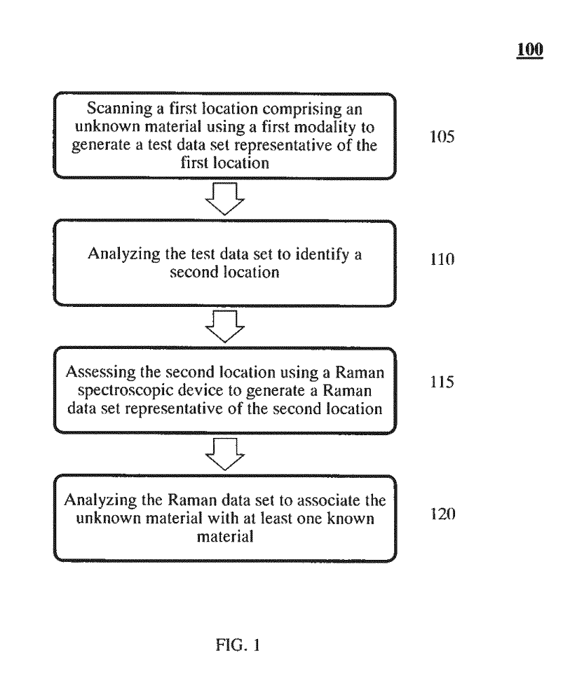

The present disclosure provides for a system and method for detecting unknown materials at standoff distances using hyperspectral imaging and Raman spectroscopic methods. FIG. 1 is illustrative of one embodiment of a method of the present disclosure. The method 100 may comprise scanning a first location comprising an unknown material using a first modality to generate a test data set representative of the first location in step 105. In one embodiment, the first location may be selected as a result of surveying a sample scene. Such knowledge of the sample area and/or field of view (“FOY”) a ay be valuable for operator control and for sensor fusion. This may be accomplished using a video capture device which outputs a dynamic image of the sample scene. In one embodiment, the video capture device may comprise a color video camera. The dynamic image may then be analyzed and a target area selected based on at least one of: size, shape, color, or other attribute of one or more objects in the sample scene. These objects may comprise samples which are suspected of comprising unknown materials. In one embodiment, the test data set may be generated by illuminating the first location to generate at least one plurality of interacted photons. The present disclosure contemplates that either active or passive illumination sources may be used. In one embodiment of the present disclosure, the target area illuminated using a solar radiation source (i.e., the sun). In another embodiment, a tunable illumination source may be used. These interacted photons may comprise at least one of: photons absorbed by the sample, photons reflected by the sample, photons scattered by the sample, photons emitted by the sample and combinations thereof. These interacted photons may be passed through a filter and detected to generate the test data set. In one embodiment, the filter may comprise a tunable filter configured to filter the interacted photons into a plurality of wavelength bands. The tunable filter may comprise at least one of: a multi-conjugate tunable filter, a liquid crystal tunable filter, acousto-optical tunable filters, Lyot liquid crystal tunable filter, Evans Split-Element liquid crystal tunable filter, Sole liquid crystal tunable filter, Ferroelectric liquid crystal tunable filter, Fabry Perot liquid crystal tunable filter, and combinations thereof.

In one embodiment, the filter may comprise multi-conjugate filter technology available from ChemImage Corporation, Pittsburgh, Pa. This technology is more fully described in U.S. Pat. No. 7,362,489, filed on Apr. 22, 2005. entitled “Multi-Conjugate Liquid Crystal Tunable Filter” and U.S. Pat. No. 6,692,809, filed on Feb. 2, 2005, also entitled “Multi-Conjugate Liquid Crystal Tunable Filter.” In another embodiment, the MCF technology used may comprise a SWIR multi-conjugate tunable filter. One such filter is described in U.S. Patent Application No. 61/324,963, filed on Apr. 16, 2010, entitled “SWIR MCF”. Each of these patents are hereby incorporated by reference in their entireties. In another embodiment, the filter may comprise at least one of a fixed filter, a dielectric filter, and combinations thereof.

The test data set may comprise at least one of: a hyperspectral image, a spatially accurate wavelength resolved image, a spectrum, and combinations thereof. The present disclosure contemplates that a variety of hyperspectral imaging and spectroscopic modalities may be used to generate the test data set. In one embodiment, the test data set may comprise at least one of: an infrared test data set, a visible test data set, a visible-near infrared test data set, a fluorescence test data set, and combinations thereof. Infrared test data sets may further comprise at least one of: a SWIR test data set, a MWIR test data set, a LWIR test data set, and combinations thereof.

In step 110, the test data set may be analyzed to identify a second location. This analysis may be achieved by comparing the test data set to at least one reference data set. Chemometric techniques and/or pattern recognition algorithms may be used in this comparison. The applied technique may be selected from the group consisting of principle components analysis, partial least squares discriminate analysis, cosine correlation analysis, Euclidian distance analysis, k-means clustering, multivariate curve resolution, band t. entropy method, mahalanobis distance, adaptive subspace detector, spectral mixture resolution, Bayesian fusion, and combinations thereof.

In one embodiment, at least a portion of the first location and the second location overlap. The second location may be assessed in step 115 using a Raman spectroscopic device to generate a Raman data set representative of the second location. In one embodiment, the Raman data set may be generated by illuminating the second location to generate a plurality of interacted photons, passing the plurality of interacted photons through a fiber array spectral translator (FAST) device, and detecting the interacted photons to generate the Raman data set. In one embodiment, the Raman data set may comprise at least one of: a Raman spectrum spatially accurate wavelength resolved Raman image, a Raman hyperspectral image, and combinations thereof.

A FAST device, when used in conjunction with a photon detector, allows massively parallel acquisition of full-spectral images. A FAST device can provide rapid real-time analysis for quick detection, classification, identification, and visualization of the sample. The FAST technology can acquire a few to thousands of full spectral range, spatially resolved spectra simultaneously. A typical FAST array contains multiple optical fibers that may be arranged in a two-dimensional array on one end and a one dimensional (i.e., linear) array on the other end. The linear array is useful for interfacing with a photon detector, such as a charge-coupled device (“CCD”). The two-dimensional array end of the FAST is typically positioned to receive photons from a sample. The photons from the sample may be, for example, emitted by the sample, absorbed by the sample, reflected off of the sample, refracted by the sample, fluoresce from the sample, or scattered by the sample. The scattered photons may be Raman photons.

In a FAST spectrographic system, photons incident to the two-dimensional end of the FAST may be focused so that a spectroscopic image of the sample is conveyed onto the two-dimensional array of optical fibers. The two-dimensional array of optical fibers may be drawn into a one-dimensional distal array with, for example, serpentine ordering. The one-dimensional fiber stack may be operatively coupled to an imaging spectrometer of a photon detector, such as a charge-coupled device so as to apply the photons received at the two-dimensional end of the FAST to the detector rows of the photon detector.

One advantage of this type of apparatus over other spectroscopic apparatus is speed of analysis. A complete spectroscopic imaging data set can be acquired in the amount of time it takes to generate a single spectrum from a given material. Additionally, the FAST can be implemented with multiple detectors. A FAST system may be used in a variety of situations to help resolve difficult spectrographic problems such as the presence of polymorphs of a compound, sometimes referred to as spectral unmixing.

FAST technology can be applied to the collection of spatially resolved Raman spectra. In a standard Raman spectroscopic sensor, a laser beam is directed on to a sample area, an appropriate lens is used to collect the Raman scattered light, the light is passed through a filter to remove light scattered at the laser wavelength and finally sent to the input of a spectrometer where the light is separated into its component wavelengths dispersed at the focal plane of a CCD camera for detection. In the FAST approach, the Raman scattered light, after removal of the laser light, is focused onto the input of a fiber optic bundle consisting of up to hundreds of individual fiber, each fiber collecting the light scattered by a specific location in the excited area of the sample. The output end of each of the individual fibers is aligned at the input slit of a spectrometer that is designed to give a separate spectrum from each fiber. A 2-dimensional CCD detector is used to capture each of these FAST spectra. As a result, multiple Raman spectra and therefore, multiple interrogations of the sample area can be obtained in a single measurement cycle, in essentially the same time as in conventional Raman sensors.

In one embodiment, an area of interest can be optically matched by the FAST array to the area of the laser spot to maximize the collection Raman efficiency. In one embodiment, the present disclosure contemplates another configuration in which only the laser beam be moved for scanning within a FOV. It is possible to optically match the scanning FOV with the Raman collection FOV. The FOV is imaged onto a rectangular FAST array so that each FAST fiber is collecting light from one region of the FOV. The area per fiber which yields the maximum spatial resolution is easily calculated by dividing the area of the entire FOV by the number of fibers. Raman scattering only generated when the laser excites a sample, so Raman spectra will only be obtained at those fibers whose collection area is being scanned by the laser beam, Scanning only the laser beam is a rapid process that may utilize by off-the-shelf galvanometer driven mirror systems.

Referring again to FIG. 1, the Raman data set may be analyzed in step 120 to associate the unknown material with at least one known material. In one embodiment, the unknown material may be associated with at least of: a known chemical material, a known biological material, a known explosive material, a hazardous material, a drug material, and combinations thereof.

In one embodiment, the method of the present disclosure may provide for illuminating the area of interest using pulsed laser excitation and collecting said second plurality of interacted photons using time-gated detection. In one embodiment, a nanosecond laser pulse is applied to the area of interest. Additionally, a detector whose acquisition “window” can be precisely synchronized to this pulse is used.

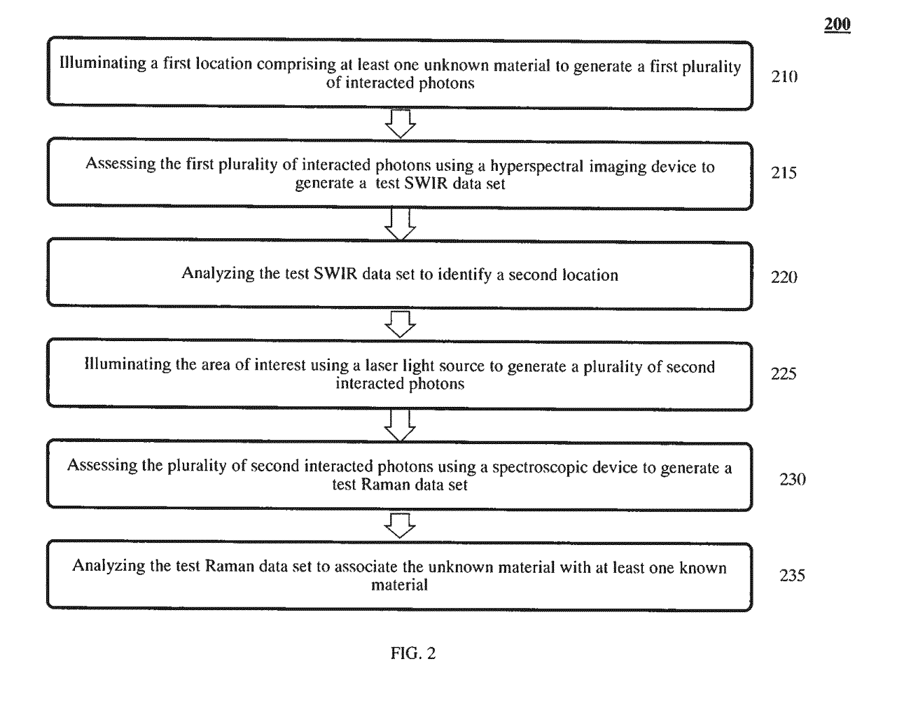

FIG. 2 is illustrative of another embodiment of a method of the present disclosure. The method 200 provides for illuminating a first location in step 210 to generate a first plurality of interacted photons. The first plurality of interacted photons may be assessed in step 215 using a hyperspectral imaging device wherein the assessing comprises generating a test SWIR data set representative of the first location. In one embodiment the test SWIR data set may comprise at least one of: a SWIR spectrum, a spatially accurate wavelength resolved SWIR image, a hyperspectral SWIR image, and combinations thereof. In step 220 the test SWIR data set may be analyzed to identify area second location. This second location may be selected based on the likelihood an unknown material is present at that location.

In one embodiment, analyzing the test SWIR data set may comprise comparing the test SWIR data set to a plurality of reference SWIR data sets in a reference database. These reference SWIR data sets may each be associated with a known material. If the comparison between the test SWIR data set and a reference SWIR data set, then the unknown material present in the area of interest may be identified as the known material.

The second location may be illuminated in step 225 to generate a second plurality of interacted photons. The second plurality of interacted photons may be assessed in step 230 using a spectroscopic device wherein the assessing comprises generating a test Raman data set representative of the second location. In one embodiment, the test Raman data set may comprise at least one of: a Raman spectrum, a spatially accurate wavelength resolved Raman image, a hyperspectral Raman image, and combinations thereof.

In step 235 the test Raman data set may be analyzed to associate the unknown material with a known material. In one embodiment, analyzing the test Raman data set may comprise comparing the test Raman data set to a plurality of reference Raman data sets in a reference database. In one embodiment, the unknown material may be associated with a known material comprising at least one of: a chemical material, a biological material, an explosive material, a hazardous material, a drug material, and combinations thereof.

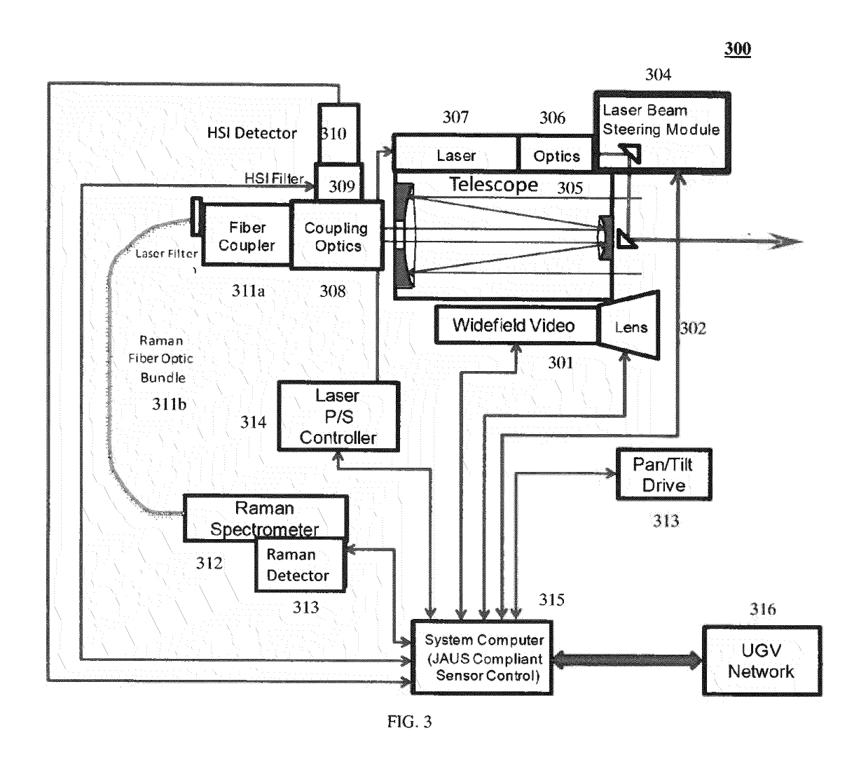

The present disclosure also provides for a system for detecting unknown materials. In one embodiment, illustrated by FIG. 3, the system 300 may comprise a widefield video capture device 301 which may be used to scan sample scenes. The video capture device 301 may be coupled to a lens 302. A telescope optic 305 may be used to focus light on various sample locations and/or collect interacted photons from these locations.

When scanning a first location, the system 300 may collect interacted photons and pass them through a coupling optic 308. The coupling optic 308 may comprise a beamsplitter, or other element, to direct interacted photons to either the filter 309 or the fiber coupler 811a. In a scanning modality, the interacted photons are directed to the filter 309. In the embodiment of FIG. 3, the filter 309 is illustrated as comprising a tunable filter. The tunable filter may filter the interacted photons into a plurality of wavelength bands and these filtered photons may be detected by a detector 310. The present disclosure contemplates a variety of different hyperspectral imaging modalities may be used to scan the first location. Therefore, the detector 310 may comprise at least one of: an InGaAs detector, a CCD detector, a CMOS detector, an InSb detector, a MCT detector, and combinations thereof. The detector 310 may be configured to generate a test data set representative of the first location.

When assessing a second location, a laser illumination source 307 may illuminate the second location to generate a second plurality of interacted photons. The system 300 may further comprise optics 306, and laser beam steering module 304. In one embodiment, the laser light source 307 may comprise a Nd:YLF laser. The interacted photons may be collected using the telescope optics 305 and pass through the coupling optic 308. In this interrogation mode, the coupling optic 308 may direct interacted photons to a fiber coupler 311a and to a FAST device 311b.

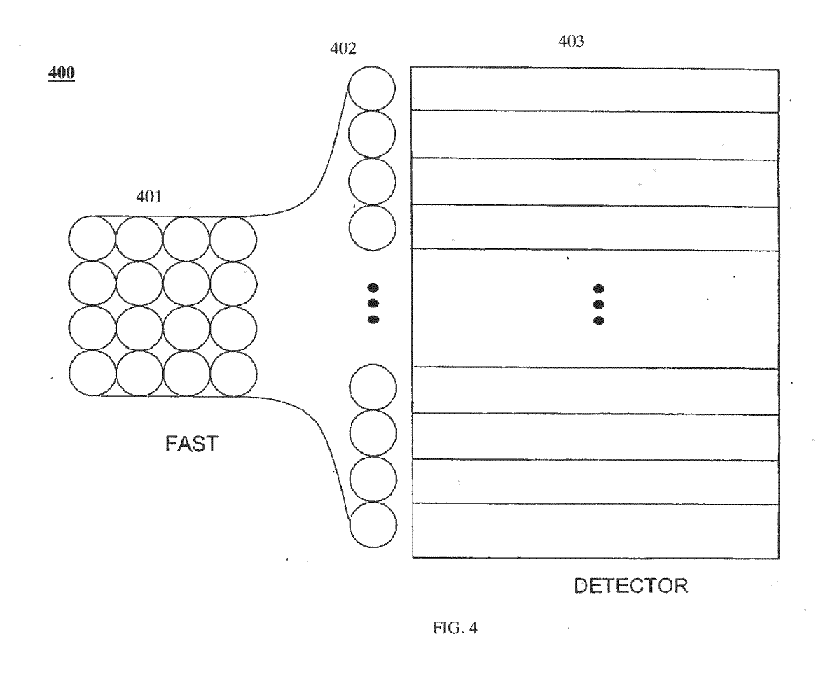

The FAST device is more fully described in FIGS. 4-6. The construction of the FAST array requires knowledge of the position of each fiber at both the imaging end and the distal end of the array as shown, for example, in the diagram of FIG. 4 where a total of sixteen fibers are shown numbered in correspondence between the imaging end 401 and the distal end 402 of the fiber bundle. As shown in FIG. 4, a FAST fiber bundle 400 may feed optical information from its two-dimensional non-linear imaging end 401 (which can be in any non-linear configuration, e.g., circular, square, rectangular, etc.) to its one-dimensional linear distal end 402, which feeds the optical information into associated detector rows 403. The distal end may be positioned at the input to a photon detector 403, such as a CCD, a complementary metal oxide semiconductor (“CMOS”) detector, or a focal plane array sensor (such as InGaAs, InSb, metal oxide semiconductor controlled thyristor (“MCT”), etc.). Photons exiting the distal end fibers may be collected by the various detector rows. Each fiber collects light from a fixed position in the two-dimensional array (imaging end) and transmits this light onto a fixed position on the detector (through that fiber's distal end).

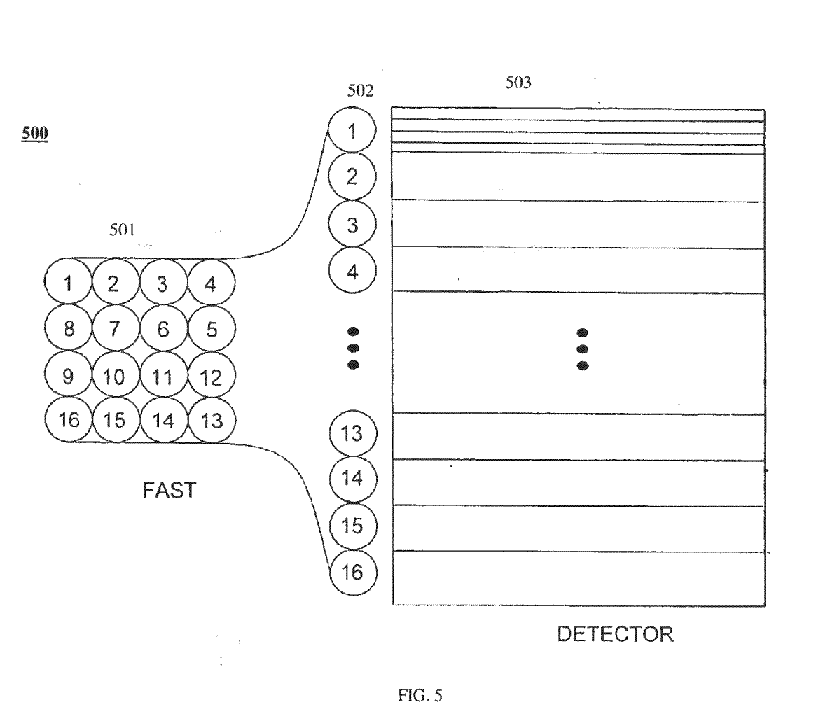

FIG. 5 is a schematic representation of a non-limiting exemplary spatial arrangement of fibers at the imaging end 501 and the distal end 502. Additionally, as shown in FIG. 5, each fiber of the FAST fiber bundle 500 may span more than one detector row in detector 503, allowing higher resolution than one pixel per fiber in the reconstructed image.

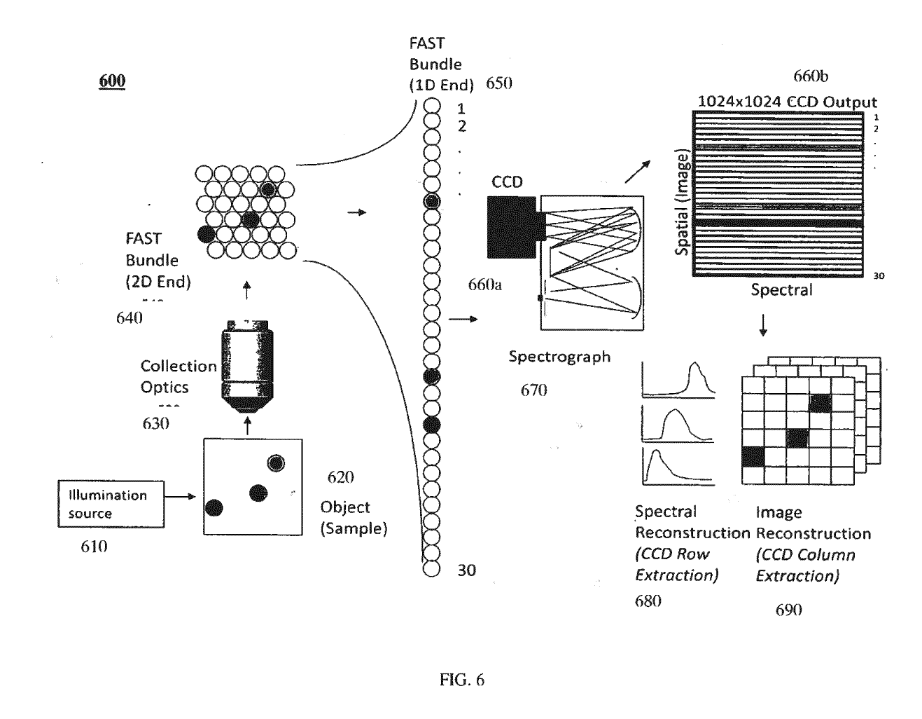

FIG. 6 is a schematic representation of a system comprising a traditional FAST device. The knowledge of the position of each fiber at both the imaging end and the distal end of the array and each associated spectra is illustrated in FIG. 6 by labeling these fibers, or groups of fibers) A, B, and C, and my assigning each a color.

The system 600 comprises an illumination source 610 to illuminate a sample 620 to thereby generate interacted photons. These interacted photons may comprise photons selected from the group consisting of photons scattered by the sample, photons absorbed by the sample, photons reflected by the sample, photons emitted by the sample, and combinations thereof. These photons are then collected by collection optics 630 and received by a two-dimensional end of a FAST device 640 wherein said two-dimensional end comprises a two-dimensional array of optical fibers. The two-dimensional array of optical fibers is drawn into a one-dimensional fiber stack 650. The one-dimensional fiber stack is oriented at the entrance slit of a spectrograph 670. As can be seen from the schematic, the one-dimensional end 650 of a traditional FAST device comprises only one column of fibers. The spectrograph 670 may function to separate the plurality of photons into a plurality of wavelengths. The photons may be detected at a detector 660a to thereby obtain a spectroscopic data set representative of said sample. 660b is illustrative of the detector output, 680 is illustrative of spectral reconstruction, and 690 is illustrative of image reconstruction.

In another embodiment, the FAST device may be configured to provide for spatially and spectrally parallelized system. Such embodiment is more fully described in U.S. patent Ser. No. 12/759,082, filed on Apr. 13, 2010, entitled “Spatially and Spectrally Parallelized Fiber Array Spectral Translator System and Method of Use”, which is hereby incorporated by reference in its entirety. Such techniques hold potential for enabling expansion of the number of fibers, which prove image fidelity, and/or scanning area.

Referring again to FIG. 3, the system 300 may further comprise a spectrometer 312 wherein the entrance slit of the spectrometer is coupled to the FAST device 311b. The spectrometer 312 may detect photons from the FAST device and generate a plurality of spatially resolved Raman spectra. A second detector 313 may be coupled to the spectrometer 312 and detect the spatially resolved Raman spectra to thereby generate a Raman data set. In one embodiment, the second detector 312 may comprise at least one of: an InGaAs detector, a CCD detector, a CMOS detector, an InSb detector, a MCT detector, and combinations thereof.

With the detection FAST array aligned to the hyperspectral FOV, Raman interrogation of the areas determined from the hyperspectral data can be done through the ALS process: moving the laser spot to those areas and collecting the FAST spectral data set. A false-color “pseudo color”) overlay may be applied to images.

The system may also comprise a pan/tilt unit 303 for controlling the position of the system, a laser P/S controller 314 for controlling the laser, and a system computer 315 for 316 although this is not necessary. The operator control unit 316 may comprise the user controls for the system and may be a terminal, a lap top, a keyboard, a display screen, and the like.

In one embodiment, the system of the present disclosure is configured to operate in a pulsed laser excitation/time-gated detection configuration. This may be enabled by utilizing an ICCD detector. However, the present disclosure also contemplates the system may be configured in a continuous mode using at least one of: a continuous laser, a shutter, and a continuous camera.

In one embodiment of the present disclosure, the SWIR portion of the system may comprise an InGaAs focal plane camera coupled to a wavelength-agile tunable filter and an appropriate focusing lens. Components may be selected to allow images generated by light reflecting off a target are to be collected over the 900 to 1700 nm wavelength region. This spectral region may be chosen because most explosives of interest exhibit molecular absorption in this region. Additionally, solar radiation (i.e., the sun) or a halogen lamp may be used as the light source in a reflected light measurement. The system may be configured to stare at a FOV or target area determined by the characteristics of the lens, and the tunable filter may be used to allow light at a single wavelength to reach the camera. By changing the wavelength of the tunable filter, the camera can take multiple images of the light reflected from a target area at wavelengths characteristic of various explosives and of background. These images can be rapidly processed to create chemical images, including hyperspectral images. In such images, the contrast is due to the presence or absence of a particular chemical or explosive material. The strength of SWIR hyperspectral imaging for OTM is that it is fast. Chemical images can be acquired, processed, and displayed quickly, in some instances in the order of tens of milliseconds.

The present disclosure also contemplates an embodiment wherein the system is attached to a vehicle and operated via unbilical while the UGV is moved (full interrogation of the system on a UGV). In another embodiment, the system described herein may be configured to operate via robotics. A small number of mounting brackets and plates may be fabricated in order to carry out the mounting sensor on the UGV.

In addition to the systems and methods contemplated by the present disclosure, software may hold potential for collecting, processing and displaying hyperspectral and chemical. Such software may comprise ChemImage Xpert® available from ChemImage Corporation, Pittsburgh, Pa.

In one embodiment, the method may further provide for applying a fusion algorithm to the test data set and the Raman data set. In one embodiment, a chemometric technique may be applied to a data set wherein the data set comprises a multiple frame image. This results in a single frame image wherein each pixel has an associated score (referred to as a “scored image”). This score may comprise a probability value indicative of the probability the material at the given pixel comprises a specific material (i.e., a chemical, biological, explosive, hazardous, or drug material). In one embodiment, a scored image may be obtained for both the test data set and the Raman data set. Bayesian fusion, multiplication, or another technique may be applied to these sets of scores to generate a fused score value. This fusion holds potential for increasing confidence in a result and reducing the rate of false positives. In one embodiment, this fused score value may be compared to a predetermined threshold or range of thresholds to generate a result. In another embodiment, weighting factors may be applied so that more reliable modalities are given more weight than less reliable modalities.

In one embodiment, the method may further provide for “registration” of images generated using different modalities. Such registration addresses the different image resolutions of different spectroscopic modalities which may result in differing pixel scales between the images of different modalities. Therefore, if the spatial resolution in an image from a first modality is not equal to the spatial resolution in the image from the second modality, portions of the image may be extracted out. For example, if the spatial resolution of a SWIR image does not equal the spatial resolution of a Raman image, the portion of the SWIR image corresponding to the dimensions of the Raman image may be extracted and this portion of the SWIR image may then be multiplied by the Raman image.

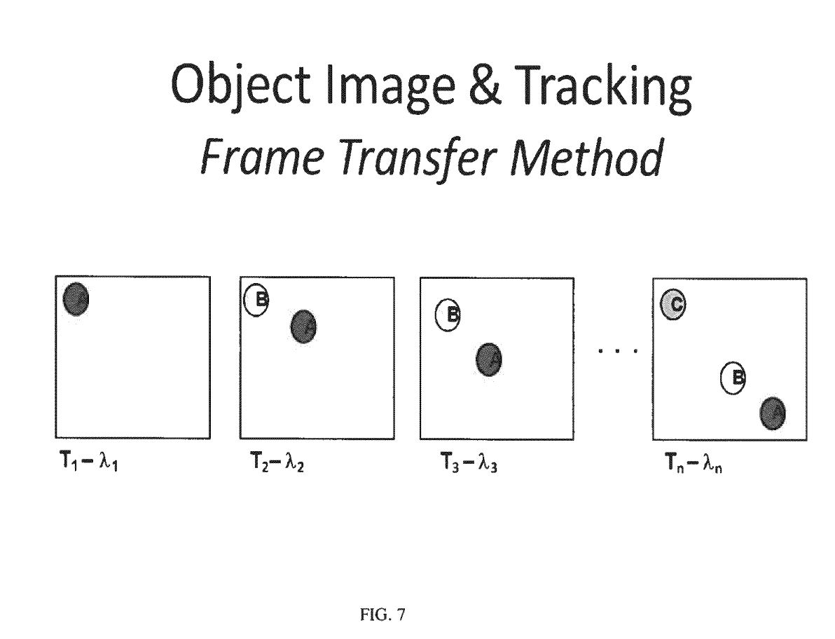

In one embodiment, the method may further comprise application of algorithms for at least one of: sensor fusion, data analysis, and target-tracking. One embodiment of a target tracking algorithm is illustrated in FIG. 7. The schematic illustrates a technique that maybe implemented for dynamical chemical imaging in which more than one object of interest passes continuously through the FOV. Such continuous stream of objects results in the average amount of time required to collect all frames for a given object being equivalent to the amount of time required to capture one frame as the total number of frames under collection approaches infinity (frame collection rate reaches a steady state). In other words, the system is continually collecting the frames of data for multiple objects simultaneously and with every new frame, the set of frames for any single object is completed. In one embodiment, the objects of interest are of a size substantially smaller than the FOV to allow re than one object to be in the FOV at any given time.

Referring again to FIG. 7, Object A is present in a slightly translated position in every frame. Each frame is collected at a different wavelength. Tracking of Object A across all frames allows the spectrum to be generated for every pixel in Object A. The same process is followed for Object B and Object C. A continual stream of objects can be imaged with the wavelengths being captured for every time, tᵢ, is updated in a continuous loop.

Although the disclosure is described using illustrative embodiments provided herein, it should be understood that the principles of the disclosure are not limited thereto and may include modification thereto and permutations thereof.

What is claimed is:

1. A system comprising:
a first detection subsystem configured to scan a first location to generate a test data set, wherein the first detection subsystem further comprises:
a first collection optics for collecting a first plurality of interacted photons generated by illuminating the first location;
a filter for filtering the first plurality of interacted photons;
a first detector for detecting the first plurality of interacted photons and generating a test data set representative of the first location;
a second detection subsystem configured to assess a second location to generate a Raman data set wherein the second detection subsystem further comprises:
a laser illumination source for illuminating the second location to generate a second plurality of interacted photons;
a second collection optics for collecting the second plurality of interacted photons;
a fiber array spectral translator device, wherein the fiber array spectral translator device further comprises a two-dimensional array of optical fibers drawn into a one-dimensional fiber stack so as to effectively convert a two-dimensional field of view into a curvilinear field of view;
a spectrometer coupled to the one-dimensional fiber stack of the fiber array spectral translator device, wherein an entrance slit of the spectrometer is coupled to the one-dimensional fiber stack to generate a plurality of spatially resolved Raman spectra;
a second detector coupled to the spectrometer to detect the spatially resolved Raman spectra to generate at least one of: a plurality of spatially resolved Raman spectra representative of said area of interest and a Raman image representative of said area of interest.

2. The system of claim 1 wherein the filter further comprises at least one of: a tunable filter, a fixed filter, a dielectric filter, and combinations thereof.

3. The system of claim 2 wherein the tunable filter further comprises at least one of: a multi conjugate tunable filter, a liquid crystal tunable filter, acousto-optical tunable filters, Lyot liquid crystal tunable filter, Evans Split-Element liquid crystal tunable filter, Sole liquid crystal tunable filter, Ferroelectric liquid crystal tunable filter, Fabry Perot liquid crystal tunable filter, and combinations thereof.

4. The system of claim 1 wherein the Raman data set further comprises at least one of: a Raman spectrum, a spatially accurate Raman image, a hyperspectral image, and combinations thereof.

5. The system of claim 1 wherein the first detector is configured to generate the test data set wherein the test data set comprises at least one of: an infrared test data set, a visible test data set, a visible-near infrared test data set, a fluorescence test data set, and combinations thereof.

6. The system of claim 5 wherein the e infrared test data set further comprises at least one of: a SWIR test data set, a MWIR test data set, a LWIR test data set, and combinations thereof.

7. The system of claim 1 wherein the first detector comprises at least one of: an InGaAs detector, a CCD detector, a CMOS detector, an InSb detector, a MCI detector, and combinations thereof.

8. The system of claim 1 wherein the second detector comprises at least one of: a CCD detector, a CMOS detector, an InGaAs detector, an InSb detector, a MCI detector, and combinations thereof.

9. The system of claim 1 further comprising at least one processor wherein the processor is configured to analyze at least one of: the test data set, the Raman data set, and combinations thereof.

10. The system of claim 9 wherein the processor is further configured to analyze the test data set to identify the second location.

11. The system of claim 1 further comprising at least one reference data set wherein each reference data set corresponds to a known material.

12. The system of claim 11 wherein the known material further comprises at least one of: a chemical material, a biological material, an explosive material, a hazardous material, an illicit drug material, and combinations thereof.

13. The system of claim 1 further comprising an active illumination source configured to illuminate the first location to generate the first plurality of interacted photons.

14. The system of claim 1 further comprising a tunable illumination source.

15. The system of claim 1 further comprising a video capture device for outputting a dynamic image of at least one of: the first location, the second location, and combinations thereof.

16. The system of claim 1 wherein the first detection system is configured to operate using a passive illumination source.

17. The system of claim 1 wherein the first detection subsystem further comprises at least one of: a zoom lens, a telescope optic, and combinations thereof.

18. The system of claim 1 wherein the second detection subsystem further comprises at least one of: a zoom lens, a telescope optic, and combinations thereof.

19. The system of claim 1 wherein the first detection subsystem is configured to operate in at least one of the following modalities: stationary, on-the-move, and combinations thereof.

20. The system of claim 1 wherein the second detection subsystem is configured to operate in at least one of the following modalities: stationary, on-the-move, and combinations thereof.

21. The system of claim 1 wherein at least one of the first detection system and the second detection system are configured to operate via robotics.

22. The system of claim 1 wherein the system is mounted onto a vehicle.

23. The system of claim 1 wherein the first detection subsystem is configured to generate the test data set using pulsed laser excitation and time-gated detection.

24. The system of claim 1 wherein the second detection subsystem is configured to generate the Raman data set using pulsed laser excitation and time-gated detection.
